(19) United States
(12) Patent Application Publication
(10) Pub. No.: US 2003/0236678 A1
(43) Pub. Date: Dec. 25, 2003

(54) Automated process for pharmaceutical printed component production

(76) Inventor: David A. Holness, Smyrna, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/177,994

(22) Filed: Jun. 24, 2002

(51) Int. Cl. G06F 17/60

(52) U.S. Cl. 705/1

(57) ABSTRACT

In a method for producing pharmaceutical printed components such as labels, package inserts, pamphlets and brochures from an organizations automated manufacturing process, the integrated printing solution provides the utility of producing on demand, a specific amount of materials, at a specific physical place, available at a specific time with the information content specific to its intended consumer. The automated process for pharmaceutical printed components provides status information as to its ability to perform said routines and the job state at any given time during its operation via an electronically integrated communication network.

### BACKGROUND OF THE INVENTION

Pharmaceutical products cannot be dispatched to customers without their accompanying documentation. The traditional process to produce pamphlets and labeling is laborious, iterative and fraught with opportunities for error. In the case of pharmaceutical products, producing labeling once approved by the company's regulatory group and the FDA involves many steps. The process includes typesetting, plate making, proof developing, pre-flight (101) and finally printing (102) to produce an inventory of documentation (103) which is soon outdated due to changes in a product's formulary or its interaction with other drugs, and is either used up (104) or discarded (105). Regulated products with dated information accompanying it, such as pharmaceutical product inserts, pamphlets and labels are often obsolete by the time they are distributed with the product putting the consuming public at greater risk.

References Cited:

Patent Number: U.S. Pat. No. 6,328,519 Dated: Dec. 11, 2001

Title: Method and Device for Producing Printed Products

Patent Number: U.S. Pat. No. 6,095,740 Dated: Aug. 1, 2000

Title: Method of Manufacturing Books or Brochures

Patent Number: U.S. Pat. No. 6,070,391 Dated: Jun. 6, 2000

Title: Method for Producing Printed Products and Products Produced Thereby

Patent Number: U.S. Pat. No. 4,939,764 Dated: Jul. 3, 1990

Title: Label Generation Apparatus

Patent Number: U.S. Pat. No. 3,619,327 Dated: Nov. 9, 1971

Title: Packaging Production

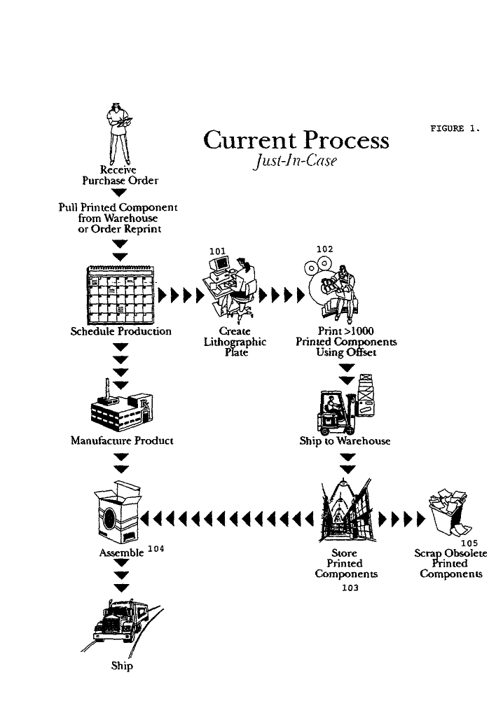

The following diagram, FIG. 1 depicts the steps involved in the current process of developing and producing pharmaceutical printed components.

### BRIEF SUMMARY OF THE INVENTION

The process described herein is a way to manufacture pharmaceutical printed components to production order, on-demand and to guarantee lead times. Thereby, assuring the right documents, in the right place, at the right time, in the right quantity needed with the document content built to specific languages, versions, markets, etc. The newly reengineered production process is greatly simplified and includes three stages:

Input: Printed components are input either by creating electronic documents using popular desktop authoring systems, or by capturing hardcopy, microfiche and microfilm documents on scanners.

Process: Once printed components are created or captured, they are stored in an electronic warehouse or digital library so they are always ready for use. The solution ensures that the latest version of the document is always readily accessible for viewing, printing, updating, etc.

Output: When an order from the MRP system schedules the manufacturing of printed components (201), the most current bill of material is then printed and finished for distribution (202). Since the printed component is in digital format, only what is required is produced, just-in-time, when and where needed for assembly (203) and shipping (204) with the matching quantity of product.

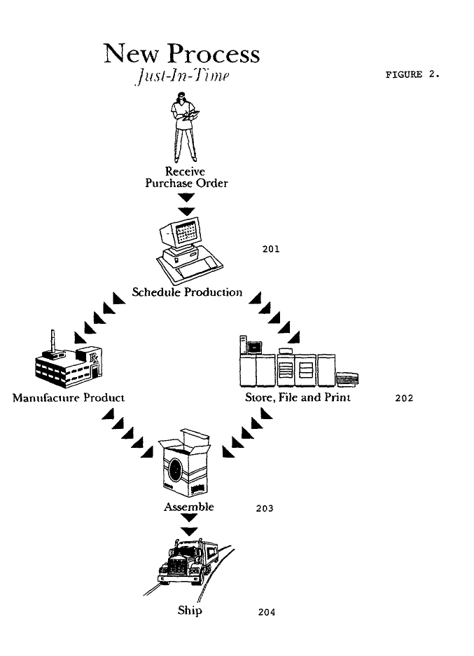

The following diagram, FIG. 2 depicts the steps involved in the proposed process of developing and producing pharmaceutical printed components.

### DETAILED DESCRIPTION OF THE INVENTION

First, the printed component must be designed, quality approval obtained, and the postscript file placed on a document repository server (301), this computer may be one of many brands, e.g. IBM, HP, Dell, etc. If the printed component file required for a job does not exist on the document repository server when a request is received from the manufacturing resource planning (MRP) system e.g. SAP, an error will be returned to the MRP system. Orders are entered into the MRP system; forecasting, scheduling and planning are fed into the MRP system; and, eventually, a product order is dispatched to manufacturing. When the order is released to manufacturing, a status field within the MRP system changes and triggers a user exit. The user exit will gather the Bill of Materials information and other information (from MRP) required for the production of a printed component and sends the information, via network, to the document repository server. When the document repository server receives the information from the MRP system, it verifies the required printed component file exists and submits it to the line control desk for printing (302). The priorities assigned within the MRP system will be maintained. In order to process printed components for a number of work centers, some optimization will be done to try to make consistent, printed component size, material and finishing when possible.

The label, pamphlet, insert, etc. artwork will be printed (303) with an associated barcode as required by industry representing the production lot for each order dispatched from the MRP system. This barcode will serve as an indicator of the product contents, versioning and distribution requirements. After a printed component is produced, it will proceed through an Inline Inspection Station (304). Any gross defects noted will stop the process and require an operator to resolve the problem (dirty drum, corona wire, etc.). After inline inspection, the printed component will be appropriately finished or converted for downstream processing and distribution (305). A final printed component count will be generated from scanned barcodes in the Inline Inspection Station and be submitted to the MRP system for tracking.

If an error is detected in the Inline Inspection Station requiring an operator for resolution, a mark will be made on the printed component stock by the station. As the process continues, the mark will alert the offline tracking station (306) to the location of the bad printed components at the end the current run and submit the accumulated printed component count to the Document Repository Server. The Document Repository Server will resubmit a print job for the number of re-prints of components required to finish the job.

While the process is running, the Document Repository Server will monitor the production state noting any alarms, and keeping track of available paper, disk space, memory space, jobs in queue, etc. The Document repository server will also monitor the feeding, finishing and converting equipment having the signaling capability configured inline. Entries will be made into a log as well as the situation highlighted.

When the scheduled downtime arrives, the Document repository server will display instructions informing the operator of the tasks to be performed. An audit trail will be maintained recording the tasks performed and the operator performing them.

Hardware Controls:

A line control PC (302) will communicate to all intelligent subsystems such as the Printer (303), Inspection Station (304), Finishing and, or Converting equipment (305) configured as part of the inline production process. This PC will also process analog and digital signals from the devices in the production line. The Inspection Station will also have its own tool control PC that will house the vision system processor, for doing printed component inspection and correction of variance from a golden template stored in its memory. When possible, based upon printer intelligence, protocols, signals, etc., automatic adjustments are carried out to the printing device by the inspection station. Where this automatic adjustment is not possible an audible indicator will alert the operator to make manual adjustments. The line control PC will act as the line supervisor and print job management controller.

Software Controls:

The production line will use the printer manufacturers, commercially available print job management system software. The vision inspection system station will use the commercially available software from the visual inspection manufacturer. Some customization of the existing software may be required for this specific printed component manufacturing system configuration.

Operator Interface:

The Inspection Station has its own on/off pushbutton controls as well as a graphical user interface for its PC. The Line Control PC also has its own on/off pushbutton controls and a graphical user interface for its PC.

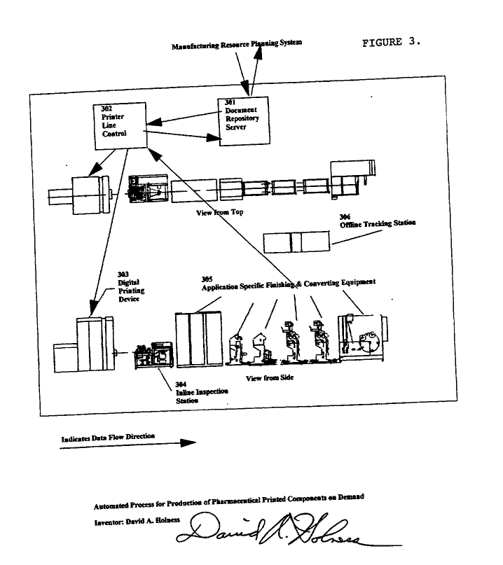

The following diagram, FIG. 3 depicts the major components involved in the proposed process of developing and producing pharmaceutical printed components.

I claim:

1. A method by which required printed components that accompany, containerize, identify or support a product's claim in the market are manufactured as a bill of material on demand during the manufacturing cycle for that product.

2. The method according to claim 1, that manufacturing of printed bill of material is triggered by organization's manufacturing or enterprise resource planning system.

3. The method according to claim 1, further comprising a process to control mode of distribution based upon availability and use of the electronic bill of material.

4. The method according to claim 1, further comprising a process for inspecting the quality of printed components while operation is in progress for possible exception handling.

5. The method according to claim 1, wherein the process automates the accounting for and management of raw materials and devices used in the creation of printed components.
